(19) United States
(12) Patent Application Publication
(10) Pub. No.: US 2010/0199849 A1
(43) Pub. Date: Aug. 12, 2010

(54) COFFEE MAKER

(75) Inventors: MingChia Wu, Chiayi County (TW); ShengFang Cheng, Tainan city (TW)

Correspondence Address: RABIN & Berdo, PC, 1101 14TH STREET, NW, SUITE 500, WASHINGTON, DC, 20005, US

(73) Assignee: TSANN KUEN(CHINA) ENTERPRISE CO., LTD., Fujian (CN)

(21) Appl. No.: 12/680,029

(22) PCT Filed: Nov. 28, 2007
(86) PCT No.: PCT/CN07/03352

§ 371 Date: Mar. 25, 2010

(30) Foreign Application Priority Data
Sep. 30, 2006 (CN) 200610069112.8

(51) Int. Cl. A47J 31/42; A47J 31/44

(52) U.S. Cl. 99/286; 99/300

(57) ABSTRACT

A coffee maker is disclosed. The coffee maker includes a grinding device, a brewing device and a driving device, wherein the grinding device is used to grind coffee beans into ground coffee. The brewing device is used to receive the ground coffee transmitted from the outlet of the grinding device. The driving device is used to move the outlet of the grinding device, thereby letting an opening of the outlet selectively locate on a brewing chamber of the brewing device.

### FIELD OF THE INVENTION

The present invention relates to a coffee maker, particularly, to a coffee maker which can prevent the steam from entering into the grinding device.

### BACKGROUND OF THE INVENTION

A coffee maker with auto-grinding function can brew a pot of fresh coffee only by putting coffee beams into the coffee maker and then pressing the button, thus it is favored by the users because compared to traditional coffee maker, this coffee maker with auto-grinding function is more convenient in operations.

However, this coffee maker with auto-grinding function usually causes the problem that the grinding device contaminated by the steam, because in the coffee brewing the stream will be generated, and the steam will enter into the grinding device via the pipe for transmitting ground coffee, the grinding device will be more and more damp, thus the ground coffee or coffee beam in the grinding device can not be used for containing too much humidity. Therefore, after brewing, the entire grinding device of this coffee maker with auto-grinding function must be cleaned and airing before being used again. Thus though this coffee maker with auto-grinding function can brew a pot of coffee conveniently, but the subsequent complex cleaning operations will spend much time and force of the users, therefore, it is not only inconvenient in use, but also can not meet the requirements of the users.

### SUMMARY OF THE INVENTION

Accordingly, an improved coffee maker with auto-grinding function is needed to overcome the disadvantages that the grinding device contaminated by the stream in traditional coffee maker with auto-grinding function, so as to facilitate the users.

In one aspect, the present invention provides a coffee maker with auto-grinding function, by adding a driving device, the position of the transmitting pipe connected to the grinding device is changed, so that the stream generated by the hot water filled into the brewing device will not enter into the grinding device via the transmitting pipe, thus the problem of the grinding device contaminated by the stream is overcome.

In another aspect, the present invention provides a coffee maker which can prevent the stream contamination, by a railway disposed between the outlet and the brewing device, the stream generated by the hot water filled into the brewing device will be blocked by the railway and will not enter into the grinding device via the transmitting pipe, thus the problem of the grinding device contaminated by the stream is overcome.

According to a preferred embodiment, the coffee maker comprises at least a grinding device, a brewing device and a driving device, wherein the grinding device is used to grind coffee beans into ground coffee. The brewing device is used to receive the ground coffee transmitted from the outlet of the grinding device. The driving device is used to move the outlet of the grinding device, thereby letting an opening of the outlet selectively locate on a brewing chamber of the brewing device.

According to another preferred embodiment of the present invention, the coffee maker comprises at least a grinding device, a railway, a brewing device and a driving device, wherein the grinding device is used to grind coffee beans into ground coffee. The brewing device is used to receive the ground coffee transmitted from the outlet of the grinding device. The railway disposed between the outlet of the grinding device and brewing device, herein the railway having an opening located on the brewing chamber of the brewing device. The driving device is used to move the outlet with respect to the brewing device to a position between a first position and a second position, herein said first position is on the brewing device, said second position is removed from the brewing device, when the brewing device is receiving the ground coffee from the grinding device, the opening of the outlet is in the first position, when the brewing device is receiving the hot water, the opening of the outlet is in the second position.

According to a preferred embodiment, said brewing device can be, for example, a removable coffee basket.

According to a preferred embodiment, said outlet can be, for example, a transmitting pipe.

According to a preferred embodiment, said grinding device can be, for example, a grinding cutter and a motor connected to said grinding cutter.

The coffee maker with auto-grinding function abovementioned, because it is change the position of the transmitting pipe connected to the grinding device by mounting a driving device on the grinding device, so that the opening of the transmitting pipe is removed from the brewing device, thus the stream generated by the hot water of the brewing device provided by the water-supply device will not enter into the grinding device via the transmitting pipe, therefore, the problem of the grinding device contaminated by the stream is overcome. So compared to the other coffee makers with auto-grinding function, the structure of the present invention can effectively present the steam from entering into the grinding device via the transmitting pipe.

### BRIEF DESCRIPTION OF THE DRAWINGS

A preferred embodiment of this invention describing its characteristics, purposes and functions is to be detailedly illustrated as follows, with reference to the attached drawings, in which:

FIG. 1A is a perspective view of the coffee maker with auto-grinding function of the present invention according to a preferred embodiment;

FIG. 1B is an exploded view of the grinding device in FIG. 1;

FIG. 1C illustrates the assembled grinding device in FIG. 1; and

FIG. 1D illustrates the using state of the grinding device in FIG. 1.

### LIST OF REFERENCE NUMERALS

100: coffee maker
110: base
120: housing
130: brewing device
132: brewing chamber
140: carafe
150: grinding device
152: inlet
152a: opening
152b: upper lid
154: grinder
154a: cutter
154b: motor
156: outlet
156a: opening
158: toothed disc
160: driving device
162: driving motor
164: gear
170: railway
170a: opening
172, 174: two ends
182, 184: microswitch
190: retainer

### DETAILED DESCRIPTION OF THE PREFERRED EMBODIMENT

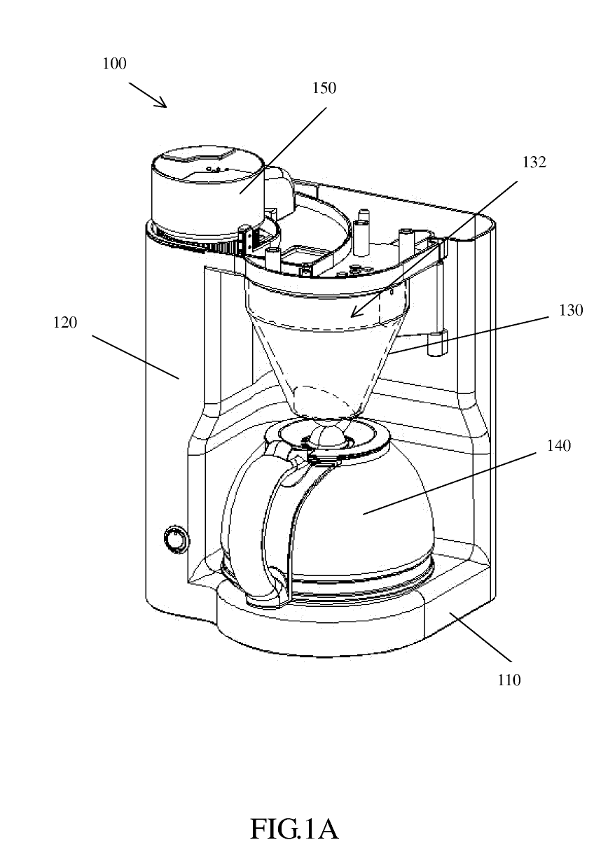

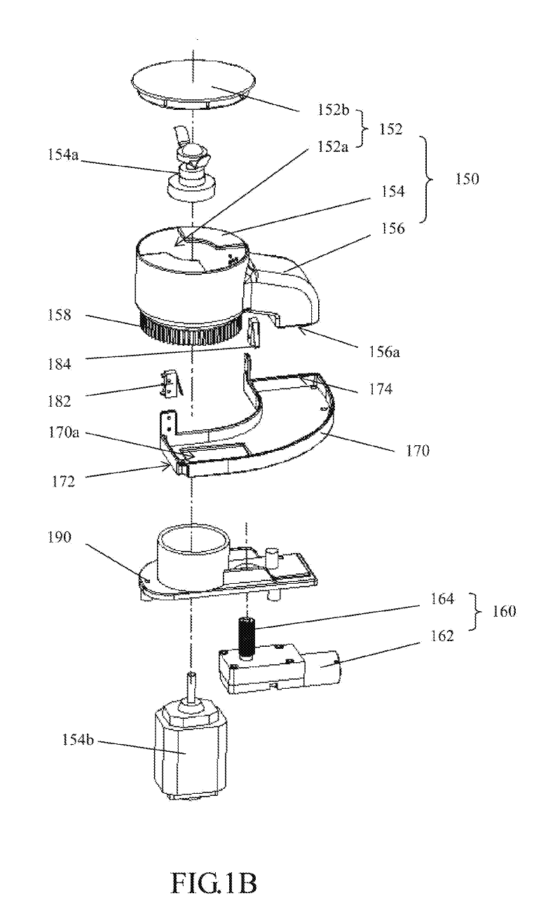

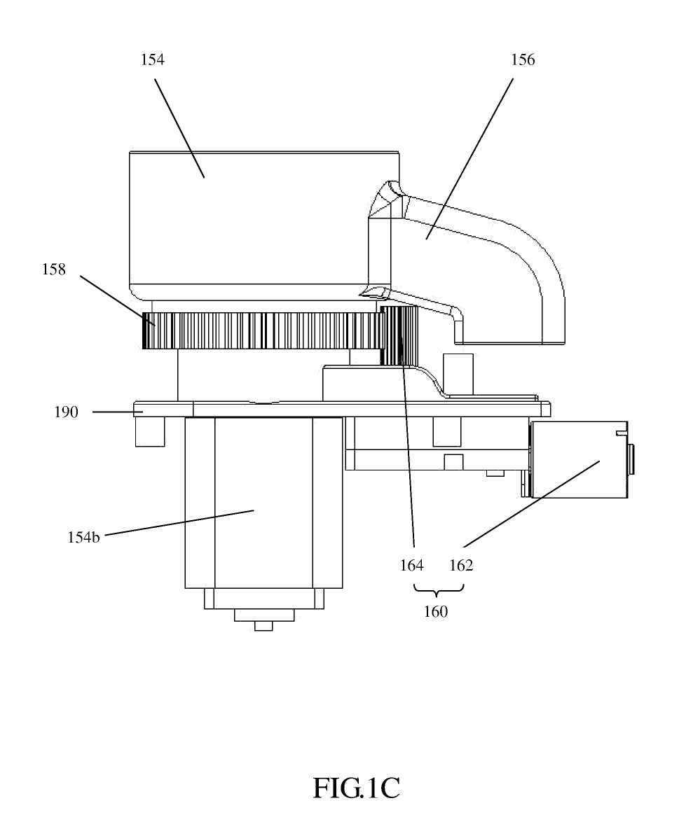

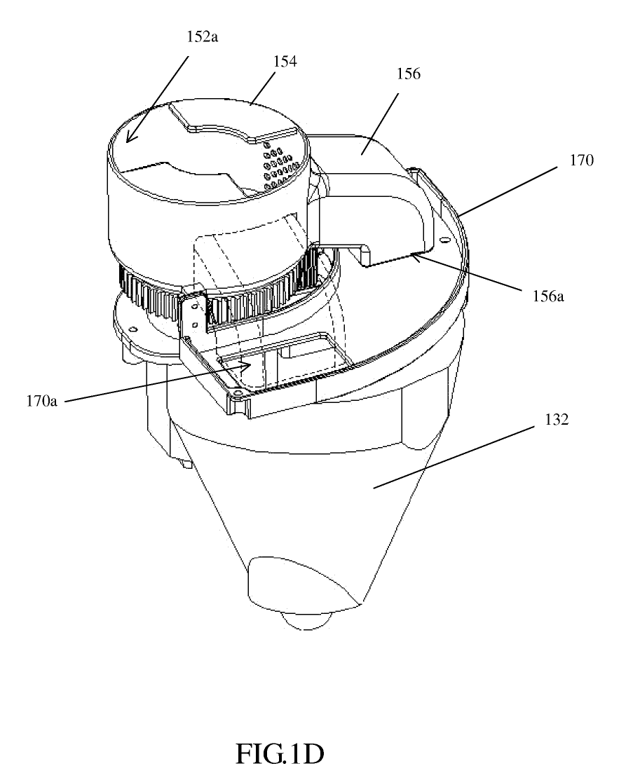

Referring to FIG. 1A and FIG. 1B, they are a perspective view of the coffee maker with auto-grinding function of the present invention according to a preferred embodiment and an exploded view of the grinding device in FIG. 1 respectively. The coffee maker 100 with auto-grinding function comprises a base 110, a housing 120, a brewing device 130 and a carafe 140, herein the housing 120 is disposed on the base 110 for providing hot water and ground coffee to brewing device 130. the carafe 140 is disposed below the brewing device 130 for receiving the coffee liquid flowed out from the brewing device 130. The brewing device 130 is removable coffee basket detachably mounted on the housing 120. In this embodiment, the housing 120 comprises a water-supply device (not shown) and a grinding device 150 for providing coffee ground, the water-supply device is well-known in the art, so it is not detailedly described for the sake of brevity. The grinding device 150 used to grind coffee beans into ground coffee comprises an inlet 152, a grinding device 154 and an outlet 156, herein the coffee beans is input into the grinding device 154 via the inlet 152. The grinding device 154 has a grinding cutter 154a for grinding the coffee beans into ground coffee. Then the ground coffee is transmitted to the brewing device 130 via the outlet 156 so as to be brewed by hot water subsequently in the brewing device 130. So the brewing device 130 is used to receive the ground coffee transmitted by the outlet 156 of the grinding device 150, herein the brewing device 130 has a brewing chamber 132 for containing ground coffee. In this embodiment, the outlet 152 is an opening 152a with an upper lid 152b thereon, without limitation, the outlet 152 also can be a feed hopper having space for containing coffee beans. In addition, the outlet 156 is a transmitting pipe, and the grinding device 150 is near to the brewing device 130, the grinding device 150 comprises a grinding cutter 154a and a motor 154b connected to the grinding cutter 154a, herein the motor 154b is used to drive the grinding cutter 154a to rotate so as to grind the coffee beans in the grinding device 154 into ground coffee. The driving device 160 is used to move the outlet 156 of the grinding device 150, thereby let the opening 156a of the outlet 156 selectively locate on the brewing chamber 132 of the brewing device 130. In this embodiment, the driving device 160 is engage with the grinding device 150, the driving device 160 comprises a driving motor 162 and a gear 164 connected to the driving motor 162, herein the grinding device 150 comprises a toothed disc 158 meshed with the gear 164, as is shown in FIG. 1C, the gear 164 of the driving device 160 is mesh with and is driven by the gear disc 158 to rotate the grinding device 150, thereby move the outlet 156 of the grinding device 150. Referring to FIG. 1D, which illustrates the using state of the grinding device 150 in FIG. 1, the driving device 160 is used to move the outlet 156 with respect to the brewing device 130 to a position between a first position (broken line) and a second position (solid line), herein the first position is on the brewing device 130 and the second position is removed from the brewing device 130. When the brewing device 130 received the ground coffee generated from the grinding device 150, the opening 156a of the outlet 156 is on the first position, while when the brewing device is receiving the hot water, the opening 156a of the outlet 156 is on the second position. In this embodiment, a railway 170 is further disposed between the outlet 156 and brewing device 130, herein the railway 170 is used to block the opening 156a of the outlet 156 to prevent the steam or other contaminations from entering into the grinding device 154 via the opening 156a. It must noted that the railway 170 has an opening 170a located on the brewing chamber 132 of the brewing device 130, when the opening 156a of the outlet 156 aligned to the opening 170a of the railway 170, the ground coffee of the grinding device 150 can be drop from the opening 156a of the outlet 156 to the brewing device 130 via the opening 170a of the railway 170. In this embodiment, two microswitches 182, 184 are disposed on the two ends 172, 174 of the railway 170 respectively, when the outlet 156 moved to the two ends 172, 174 of the railway 170, the microswitches 182, 184 will be contacted, then the driving device 160 will stop to avoid that the subsequent movement make the outlet 156 rub against the shell of the housing 120. In this embodiment, the railway is a disc having one quarter of a circle, without limitation, it also can be a disc with half of a circle, what is essential is that the opening 156a of the outlet 156 can be blocked by a part of the railway, and the ground coffee can be dropped to the brewing device 130 from the opening 156a of the outlet 156 via the other part of the railway. It is can be understood that the opening 170a of the railway 170 is larger than the opening 156a of the outlet 156. In this embodiment, the driving device 160 and the motor 154b of the grinding device 150 can be fixed by a retainer 190.

In summary, the coffee maker with auto-grinding function of the present invention, characterized by a driving device mounted on the grinding device, the opening position of the outlet of the grinding device is changed by the driving device, when the ground coffee is transmitted by the grinding device, the opening position of the outlet of the grinding device is on the coffee basket, when the hot water is transmitted by the water-supply device the opening position of the outlet of the grinding device is removed from the coffee basket, thereby to prevent the stream generated by the hot water in the coffee basket from entering the grinding device via the outlet by upwardly diffusion, and further prevent the grinding device from being contaminated by the stream. So compared to the other coffee makers with auto-grinding function in prior art, the present invention can effectively present the grinding device from being contaminated by the stream. In the present invention, a railway also disposed between the outlet of the grinding device and the coffee basket, the railway is used to block the opening of the outlet to prevent the stream or other contamination from entering the grinding device via the opening of the outlet, when the ground coffee is to be transmitted to the coffee basket by the grinding device, the opening of the outlet will be on the opening of the railway, therefore the ground coffee can enter into by the opening of the railway, when the hot water is to be transmitted to the coffee basket, the opening of the outlet will be removed from the opening of the railway, therefore to prevent the stream from entering into the grinding device via the opening of the railway, thus can improve the reliability of the coffee maker with auto-grinding function for preventing the grinding device from being contaminated by the stream.

### INDUSTRIAL APPLICABILITY

It can be seen from the abovementioned preferred embodiment of the present invention that the coffee maker with auto-grinding function of the present invention has the following advantages: when the stream generated by the hot water diffused upwardly, the opening of the transmitting pipe of the grinding device is not on the coffee basket, thus can effectively prevent the stream entering into the grinding device via the transmitting pipe, therefore the problem of the grinding device contaminated by the stream is overcome. So compared to the other coffee makers with function of anti-stream contamination in prior art (i.e. U.S. Pat. No. 5,285,705), the present invention can effectively prevent the steam from entering into the grinding device from the interspace of the valve via transmitting pipe, which may caused by the not enough effective sealing of the valve or ground coffee adhering on the valve, thus the problem of the grinding device contaminated by the stream is overcome.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A coffee maker comprising:
at least a grinding device, used to grind coffee beans into ground coffee, herein said grinding device comprising an outlet;
a brewing device, used to receive the ground coffee transmitted from said outlet of said grinding device, herein said brewing device comprising a brewing chamber; and
a driving device, used to move the outlet of said grinding device, thereby letting the first opening of said outlet selectively locate on said brewing chamber of said brewing device.

2. The coffee maker according to claim 1, wherein said outlet is a transmitting pipe.

3. The coffee maker according to claim 2, wherein said driving device is engaged with said grinding device.

4. The coffee maker according to claim 3, wherein said driving device comprising at least:
a driving motor; and
a gear connected to said driving motor, herein said gear is used to meshly drive said grinding device to move said outlet of said grinding device.

5. The coffee maker according to claim 4, wherein said grinding device comprising at least a toothed disc meshed with said gear.

6. The coffee maker according to claim 1 further comprising a railway disposed between said outlet and said brewing device, herein said railway having a second opening, said second opening is on said brewing chamber of said brewing device.

7. The coffee maker according to claim 6 further comprising a microswitch disposed on one end of said railway, herein said microswitch is used to stop the movement of said driving device.

8. The coffee maker according to claim 6, wherein said railway is a disc having one quarter of a circle.

9. The coffee maker according to claim 6, wherein said driving device is used to move the outlet with respect to the brewing device to a position between a first position and a second position, herein said first position is on said brewing device, said second position is removed from said brewing device, when said brewing device is receiving the ground coffee from said grinding device, said first opening of said outlet is in the first position, when said brewing device is receiving the hot water, said first opening of said outlet is in the second position.

10. The coffee maker according to claim 1, wherein said driving device is used to move the outlet with respect to the brewing device to a position between a first position and a second position, herein said first position is on said brewing device, said second position is removed from said brewing device, when said brewing device is receiving the ground coffee from said grinding device, said first opening of said outlet is in the first position, when said brewing device is receiving the hot water, said first opening of said outlet is in the second position.

11. The coffee maker according to claim 2 further comprising a railway disposed between said outlet and said brewing device, herein said railway having a second opening, said second opening is on said brewing chamber of said brewing device.

12. The coffee maker according to claim 3 further comprising a railway disposed between said outlet and said brewing device, herein said railway having a second opening, said second opening is on said brewing chamber of said brewing device.

13. The coffee maker according to claim 4 further comprising a railway disposed between said outlet and said brewing device, herein said railway having a second opening, said second opening is on said brewing chamber of said brewing device.

14. The coffee maker according to claim 5 further comprising a railway disposed between said outlet and said brewing device, herein said railway having a second opening, said second opening is on said brewing chamber of said brewing device.

15. The coffee maker according to claim 11 further comprising a microswitch disposed on one end of said railway, herein said microswitch is used to stop the movement of said driving device.

16. The coffee maker according to claim 12 further comprising a microswitch disposed on one end of said railway, herein said microswitch is used to stop the movement of said driving device.

17. The coffee maker according to claim 13 further comprising a microswitch disposed on one end of said railway, herein said microswitch is used to stop the movement of said driving device.

18. The coffee maker according to claim 14 further comprising a microswitch disposed on one end of said railway, herein said microswitch is used to stop the movement of said driving device.

19. The coffee maker according to claim 11, wherein said railway is a disc having one quarter of a circle.

20. The coffee maker according to claim 12, wherein said railway is a disc having one quarter of a circle.

21. The coffee maker according to claim 13, wherein said railway is a disc having one quarter of a circle.

22. The coffee maker according to claim 14, wherein said railway is a disc having one quarter of a circle.

23. The coffee maker according to claim 11, wherein said driving device is used to move the outlet with respect to the brewing device to a position between a first position and a second position, herein said first position is on said brewing device, said second position is removed from said brewing device, when said brewing device is receiving the ground coffee from said grinding device, said first opening of said outlet is in the first position, when said brewing device is receiving the hot water, said first opening of said outlet is in the second position.

24. The coffee maker according to claim 12, wherein said driving device is used to move the outlet with respect to the brewing device to a position between a first position and a second position, herein said first position is on said brewing device, said second position is removed from said brewing device, when said brewing device is receiving the ground coffee from said grinding device, said first opening of said outlet is in the first position, when said brewing device is receiving the hot water, said first opening of said outlet is in the second position.

25. The coffee maker according to claim 13, wherein said driving device is used to move the outlet with respect to the brewing device to a position between a first position and a second position, herein said first position is on said brewing device, said second position is removed from said brewing device, when said brewing device is receiving the ground coffee from said grinding device, said first opening of said outlet is in the first position, when said brewing device is receiving the hot water, said first opening of said outlet is in the second position.

26. The coffee maker according to claim 14, wherein said driving device is used to move the outlet with respect to the brewing device to a position between a first position and a second position, herein said first position is on said brewing device, said second position is removed from said brewing device, when said brewing device is receiving the ground coffee from said grinding device, said first opening of said outlet is in the first position, when said brewing device is receiving the hot water, said first opening of said outlet is in the second position.

27. The coffee maker according to claim 2, wherein said driving device is used to move the outlet with respect to the brewing device to a position between a first position and a second position, herein said first position is on said brewing device, said second position is removed from said brewing device, when said brewing device is receiving the ground coffee from said grinding device, said first opening of said outlet is in the first position, when said brewing device is receiving the hot water, said first opening of said outlet is in the second position.

28. The coffee maker according to claim 3, wherein said driving device is used to move the outlet with respect to the brewing device to a position between a first position and a second position, herein said first position is on said brewing device, said second position is removed from said brewing device, when said brewing device is receiving the ground coffee from said grinding device, said first opening of said outlet is in the first position, when said brewing device is receiving the hot water, said first opening of said outlet is in the second position.

29. The coffee maker according to claim 4, wherein said driving device is used to move the outlet with respect to the brewing device to a position between a first position and a second position, herein said first position is on said brewing device, said second position is removed from said brewing device, when said brewing device is receiving the ground coffee from said grinding device, said first opening of said outlet is in the first position, when said brewing device is receiving the hot water, said first opening of said outlet is in the second position.

30. The coffee maker according to claim 5, wherein said driving device is used to move the outlet with respect to the brewing device to a position between a first position and a second position, herein said first position is on said brewing device, said second position is removed from said brewing device, when said brewing device is receiving the ground coffee from said grinding device, said first opening of said outlet is in the first position, when said brewing device is receiving the hot water, said first opening of said outlet is in the second position.
